(19) United States
(12) Patent Application Publication
(10) Pub. No.: US 2024/0258886 A1
(43) Pub. Date: Aug. 1, 2024

(54) PHASE ADJUSTMENT DEVICE AND PHASE ADJUSTMENT METHOD FOR ROTARY MACHINE

(71) Applicant: MITSUBISHI HEAVY INDUSTRIES COMPRESSOR CORPORATION, Tokyo (JP)

(72) Inventor: Seiji Ohama, Hiroshima-shi (JP)

(73) Assignee: MITSUBISHI HEAVY INDUSTRIES COMPRESSOR CORPORATION, Tokyo (JP)

(21) Appl. No.: 18/528,741

(22) Filed: Dec. 4, 2023

(30) Foreign Application Priority Data
Jan. 31, 2023 (JP) 2023-013005

(51) Int. Cl. H02K 15/00; H02K 7/116

(52) U.S. Cl. CPC H02K 15/0006; H02K 7/1166; H02K 2215/00

(57) ABSTRACT

There is provided a phase adjustment device for a rotary machine including a rotor and a stator. The phase adjustment device includes a worm wheel configured to be detachably provided to a shaft end of the rotor, and a worm portion configured to be detachably provided to the stator and mesh with the worm wheel.

### CROSS-REFERENCE TO RELATED APPLICATIONS

This application claims the benefit of priority to Japanese Patent Application Number 2023-013005 filed on Jan. 31, 2023. The entire contents of the above-identified application are hereby incorporated by reference.

### TECHNICAL FIELD

The disclosure relates to a phase adjustment device and a phase adjustment method for a rotary machine.

### RELATED ART

Rotary machines used in industrial compressors, turbo freezers, small-sized gas turbines, and the like are known. At the time of assembling such a rotary machine, it is necessary to finely adjust a phase in the circumferential direction of a rotor when incorporating a seal, assembling a coupling, and the like. However, in the case of a large-sized rotary machine, an operator cannot rotate the rotor by hand, and thus the phase is adjusted using a chain block or the like in some cases.

CN 112096650 A describes a diaphragm coupling disk device for adjusting a phase in the circumferential direction of a rotor. The diaphragm coupling disk device disclosed in CN 112096650 A can adjust the phase in the circumferential direction of the rotor by converting a sliding motion of a linear motion rack of a hydraulic stroke push rod into a force in the rotational direction of the diaphragm coupling.

### SUMMARY

In the case of the device described in CN 112096650 A, a support stand for supporting a hydraulic device, a gear, and the like is used. Thus, there is a problem in that the installation of the device is difficult when a space for installing the device cannot be secured below the coupling.

In addition, in the device of CN 112096650 A, a power supply or the like is used to drive the hydraulic device. Thus, there is a problem in that the installation may be difficult, in some cases, depending on the surrounding environment or the like.

The disclosure has been made in view of the above circumstances, and provides a phase adjustment device and a phase adjustment method for a rotary machine that are capable of reducing the installation space and easily performing phase adjustment.

In order to solve the above problems, the following configuration is adopted.

According to an aspect of the disclosure, a phase adjustment device for a rotary machine is a phase adjustment device for a rotary machine including a rotor and a stator, the phase adjustment device including: a worm wheel configured to be detachably provided to a shaft end of the rotor; and a worm portion configured to be detachably provided to the stator and mesh with the worm wheel.

According to an aspect of the disclosure, a phase adjustment method is a phase adjustment method for the rotary machine by the phase adjustment device mentioned above, the phase adjustment method including: attaching the worm portion to the stator; attaching the worm wheel to the shaft end of the rotor with the worm wheel meshing with the worm portion; and adjusting a phase of the rotor by rotating the worm portion about an axis of the worm portion by using a hand tool.

According to the disclosure, it is possible to reduce the installation space and easily perform the phase adjustment.

### BRIEF DESCRIPTION OF DRAWINGS

The disclosure will be described with reference to the accompanying drawings, wherein like numbers reference like elements.

FIG. 1 is a configuration diagram illustrating a schematic configuration of a rotary machine and a phase adjustment device according to an embodiment of the disclosure.

FIG. 2 is an enlarged view of the vicinity of a phase adjustment device according to an embodiment of the disclosure.

FIG. 3 is a diagram of a phase adjustment device as viewed from an axial direction according to an embodiment of the disclosure.

FIG. 4 is a cross-sectional view of a coupling attachment hole of a spacer according to an embodiment of the disclosure.

FIG. 5 is a cross-sectional view of a threaded hole of a spacer according to an embodiment of the disclosure.

FIG. 6 is a flowchart of a phase adjustment method for a rotary machine according to an embodiment of the disclosure.

FIG. 7 is a partial cross-sectional view of the vicinity of a shaft end when none of a phase adjustment device and a coupling hub are mounted according to an embodiment of the disclosure.

FIG. 8 is a partial cross-sectional view illustrating a state in which the above coupling hub is attached.

FIG. 9 is a partial cross-sectional view illustrating a state in which a guide bar is attached in a threaded hole of an end flange portion.

FIG. 10 is a partial cross-sectional view illustrating a state in which a guide bar is inserted into an insertion hole of a worm holding plate.

FIG. 11 is a partial cross-sectional view illustrating a state in which a worm holding plate is attached to an end flange portion.

FIG. 12 is a partial cross-sectional view illustrating a state in which a spacer is attached to a coupling hub.

FIG. 13 is a diagram illustrating a state in which a hand tool is mounted to a worm portion.

### DESCRIPTION OF EMBODIMENTS

Next, a phase adjustment device and a phase adjustment method for a rotary machine according to an embodiment of the disclosure will be described with reference to the drawings. In the present embodiment, a multistage centrifugal compressor will be described as an example of the rotary machine.

### Configuration of Rotary Machine

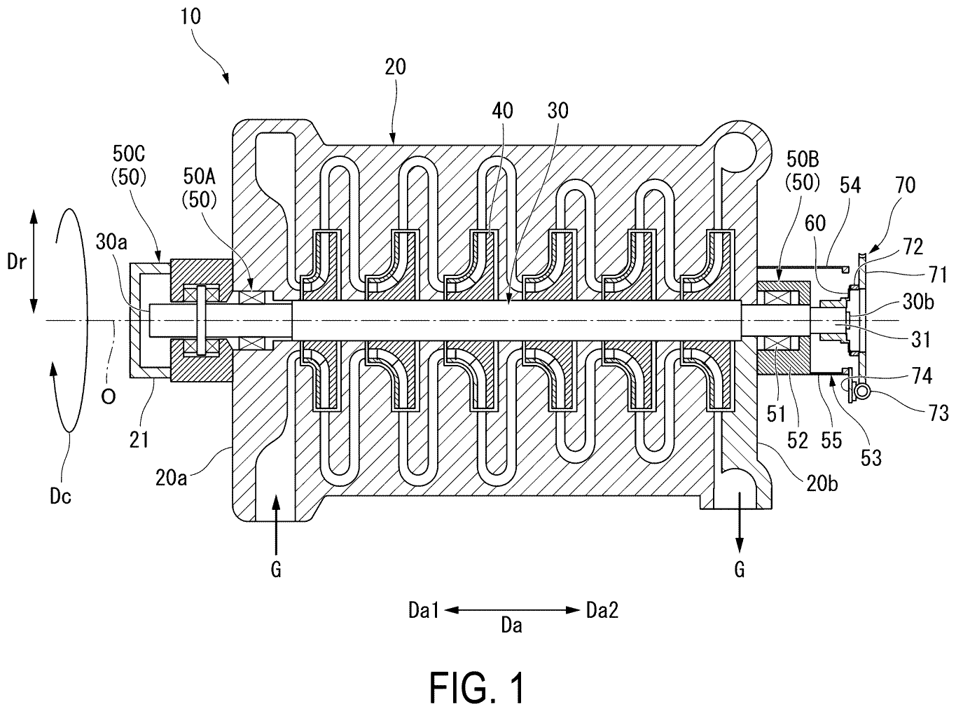

FIG. 1 is a configuration diagram illustrating a schematic configuration of a rotary machine and a phase adjustment device according to the embodiment.

As illustrated in FIG. 1, a rotary machine 10 includes a casing 20, a rotor shaft (rotor) 30, an impeller 40, a bearing device 50, an end flange portion (stator) 53, and a coupling hub 60.

The casing 20 accommodates part of the rotor shaft 30 and the impeller 40. The casing 20 has a tubular shape extending in a direction in which an axis O of the rotor shaft 30 extends (hereinafter, this direction is referred to as an axial direction Da). The casing 20 is provided with an interior space 24, in which diameter reduction and diameter expansion are repeated.

The rotor shaft 30 extends in the axial direction Da and is rotatable about the axis O relative to the casing 20. A first end portion 30a (an end portion on the left side in FIG. 1) and a second end portion 30b (an end portion on the right side in FIG. 1) of the rotor shaft 30 are each disposed outside the casing 20. In the following description, a side of a direction extending from the second end portion 30b toward the first end portion 30a in the axial direction Da is referred to as an axial direction first side Da1, and a side of a direction extending from the first end portion 30a toward the second end portion 30b in the axial direction Da is referred to as an axial direction second side Da2.

The impeller 40 compresses a process gas G taken into the casing 20 by utilizing centrifugal force. The impeller 40 is fixed to the rotor shaft 30 and is rotatable together with the rotor shaft 30. A plurality of the impellers 40 are provided at intervals in the axial direction Da, and are each accommodated in the interior space 24 of the casing 20. Although an example in which six impellers 40 are disposed is given in the present embodiment, the number of impellers 40 is not limited to six.

The bearing device 50 supports the rotor shaft 30 in a rotatable manner about the axis O. The rotary machine 10 of the present embodiment includes two journal bearing devices 50A and 50B and one thrust bearing device 50C, as the bearing device 50. The journal bearing device 50A is disposed at one end portion 20a of the casing 20, and supports the first end portion 30a of the rotor shaft 30 in a rotatable manner about the axis O. The journal bearing device 50B is disposed at or near the other end portion 20b of the casing 20, and supports the second end portion 30b of the rotor shaft 30 in a rotatable manner about the axis O.

The thrust bearing device 50C is disposed at a position close to the one end portion 20a of the casing 20. The thrust bearing device 50C restricts displacement of the rotor shaft 30 in a thrust direction while allowing the rotor shaft 30 to rotate. The thrust bearing device 50C of the present embodiment illustrates as an example a case in which a cover 21 covering the first end portion 30a of the rotor shaft 30 is included.

The journal bearing device 50B includes a bearing main body 51 and a bearing accommodating portion 52. The bearing main body 51 supports the rotor shaft 30 in a rotatable manner. The bearing main body 51 of the present embodiment supports the rotor shaft 30 at a position that is closer to the other end portion 20b of the casing 20 than a position of the second end portion 30b is. The bearing accommodating portion 52 accommodates the bearing main body 51. In one example, the bearing accommodating portion 52 is formed covering the bearing main body 51 from the outer side in a radial direction Dr with the axis O being the center. The bearing accommodating portion 52 is formed protruding from the other end portion 20b of the casing 20 toward the axial direction second side Da2.

The end flange portion 53 covers a shaft end 31 of the rotor shaft 30. Here, the shaft end 31 of the rotor shaft 30 is a portion of the rotor shaft 30 protruding toward the axial direction second side Da2 relative to the bearing accommodating portion 52. The end flange portion 53 is disposed spaced apart from the shaft end 31 of the rotor shaft 30 in the radial direction Dr. The end flange portion 53 of the present embodiment includes an upper half 54 and a lower half 55. The upper half 54 covers an upper half section of the shaft end 31, and the lower half 55 covers a lower half section of the shaft end 31. The upper half 54 is attachable to and detachable from the lower half 55. The upper half 54 and the lower half 55 of the present embodiment each have an arc shape when viewed in the axial direction Da. The lower half 55 supports the load of the upper half 54 from the lower side. Therefore, the strength of the lower half 55 is higher than that of the upper half 54. The upper half 54 of the present embodiment extends from the other end portion 20b of the casing 20 toward the axial direction second side Da2.

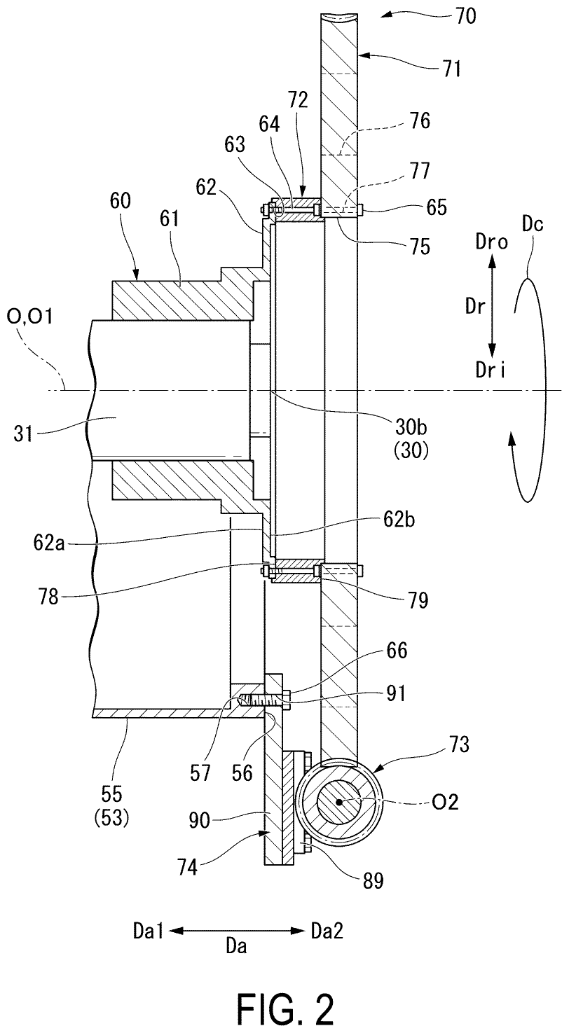

FIG. 2 is an enlarged view of the vicinity of a phase adjustment device according to the embodiment of the disclosure.

As illustrated in FIG. 2, the lower half 55 of the present embodiment extends from a lower portion of the bearing accommodating portion 52 toward the axial direction second side Da2.

The upper half 54 and the lower half 55 of the end flange portion 53 are not limited to the above-described configuration. For example, the lower half 55 may extend from the other end portion 20b of the casing toward the axial direction second side Da2. The upper half 54 may extend from the bearing accommodating portion 52 toward the axial direction second side Da2.

The end flange portion 53 has an attachment surface 56 located closest to the axial direction second side Da2 and facing the axial direction second side Da2. The attachment surface 56 has a plurality of threaded holes 57 formed at predetermined intervals in a circumferential direction Dc with the axis O being the center. The threaded holes 57 extend from the attachment surface 56 toward the axial direction first side Da1. The plurality of threaded holes 57 are originally formed for the purpose of connecting a coupling guard (not illustrated) or the like to the end flange portion 53. The coupling guard (not illustrated) is a member covering a coupling portion (not illustrated) for connecting another rotor shaft (not illustrated) of a motor, a steam turbine, or the like to the rotor shaft 30 of the rotary machine 10.

The coupling hub 60 is attached to the shaft end 31 of the rotor shaft 30. The coupling hub 60 is a member coupled to the above-described coupling portion (not illustrated). The coupling hub 60 includes a base portion 61 formed in a tubular shape centered at the axis O and a joining portion 62 extending outward in the radial direction Dr from an edge on the axial direction second side Da2 of the base portion 61. The base portion 61 is mounted to the shaft end 31 of the rotor shaft 30 by hydraulic fitting or the like.

The joining portion 62 has a surface 62a facing the axial direction first side Da1 and a surface 62b facing the axial direction second side Da2. When the coupling hub 60 is mounted to the rotor shaft 30, the surface 62b of the joining portion 62 facing the axial direction second side Da2 is disposed at the same position as the second end portion 30b of the rotor shaft 30 in the axial direction Da, or at a position on the axial direction second side Da2 relative to the second end portion 30b. The joining portion 62 of the present embodiment has a disk shape centered at the axis O, and includes a plurality of insertion holes 63, through which a fastening member 64 such as a bolt can be inserted in the axial direction Da. The plurality of insertion holes 63 are formed side by side at intervals along the outer periphery of the disk-shaped joining portion 62.

### Phase Adjustment Device

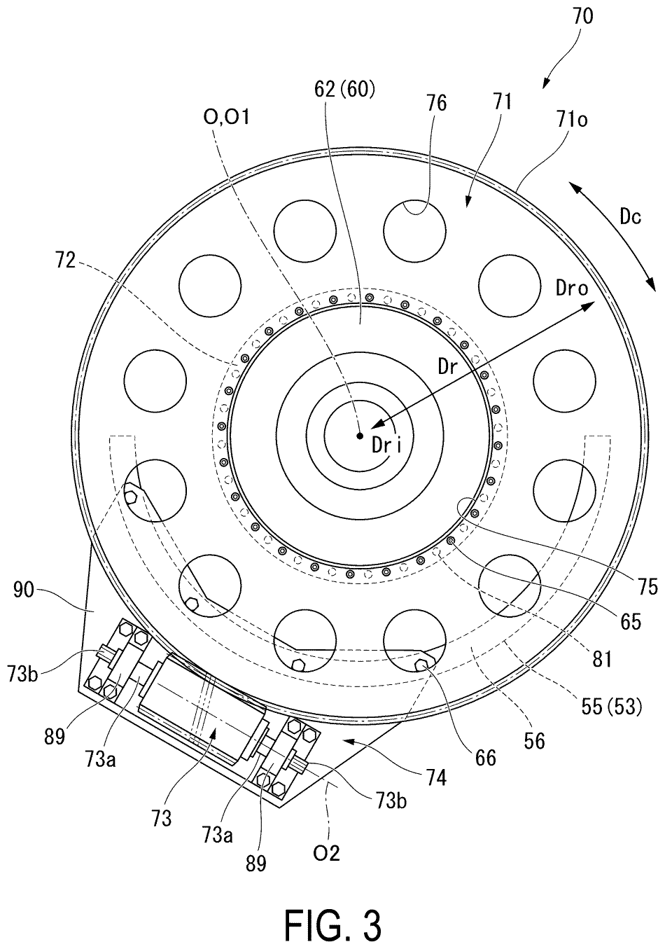

FIG. 3 is a diagram of a phase adjustment device as viewed from the axial direction according to the embodiment of the disclosure.

A phase adjustment device 70 is attached to the above-described rotary machine 10, and enables manual adjustment of the phase of the rotor shaft 30 around the axis O.

As illustrated in FIGS. 1 to 3, the phase adjustment device 70 includes a worm wheel 71, a spacer 72, a worm portion 73, and a worm holding plate 74.

Worm Wheel The worm wheel 71 is a helical gear. The worm wheel 71 is attachable to and detachable from the shaft end 31 of the rotor shaft 30. The worm wheel 71 is mounted to the shaft end 31 with such an orientation that an axis O1 passing through the center of the worm wheel 71 coincides with the axis O of the rotor shaft 30. The worm wheel 71 of the present embodiment is formed to have a diameter larger than that of the joining portion 62 of the coupling hub 60 described above. The worm wheel 71 of the present embodiment has a diameter larger than the radius of the arc of the lower half 55 of the end flange portion 53. That is, an outer peripheral portion 71o of the worm wheel 71 is disposed on a radial direction outward side Dro relative to the attachment surface 56 of the end flange portion 53.

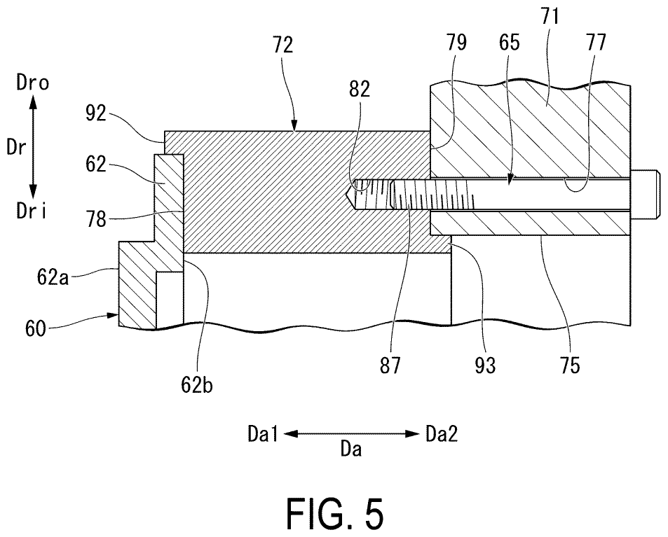

The worm wheel 71 of the present embodiment includes a first hole 75, a second hole 76, and a wheel attachment hole 77 (see FIGS. 2 and 5). The first hole 75 is formed in a circular shape centered at the axis O1 of the worm wheel 71 and is formed to have a diameter smaller than that of the joining portion 62 of the coupling hub 60. The second hole 76 is formed mainly for the purpose of lightening the worm wheel 71. The second hole 76 is formed on the radial direction outward side Dro of the first hole 75, and a plurality of the second holes 76 are formed side by side in the circumferential direction centered at the axis O1. The plurality of second holes 76 can also be used when, for example, a rope or a wire is set passing therethrough or a hook is hooked thereon when the worm wheel 71 is lifted. The wheel attachment hole 77 is formed in such a manner that a fastening member 65 such as a bolt for attaching and detaching the worm wheel 71 to and from the shaft end 31 can be inserted therethrough. A plurality of the wheel attachment holes 77 are formed at the outer periphery of the first hole 75, and are formed side by side at intervals in the circumferential direction Dc.

Spacer The spacer 72 is provided to adjust the position in the axial direction Da of the worm wheel 71. In one example, the spacer 72 is provided for the purpose of offsetting the position in the axial direction Da of the worm wheel 71 from the position of the coupling hub 60 toward the axial direction second side Da2. As illustrated in FIGS. 2 and 3, the spacer 72 has a ring shape when viewed in the axial direction Da, and includes a first surface 78 facing the axial direction first side Da1 and a second surface 79 facing the axial direction second side Da2. The thickness of the spacer 72, in other words, the dimension from the first surface 78 to the second surface 79 is determined in accordance with the distance in the axial direction Da between the surface 62b of the coupling hub 60 and the attachment surface 56 of the lower half 55 of the end flange portion 53.

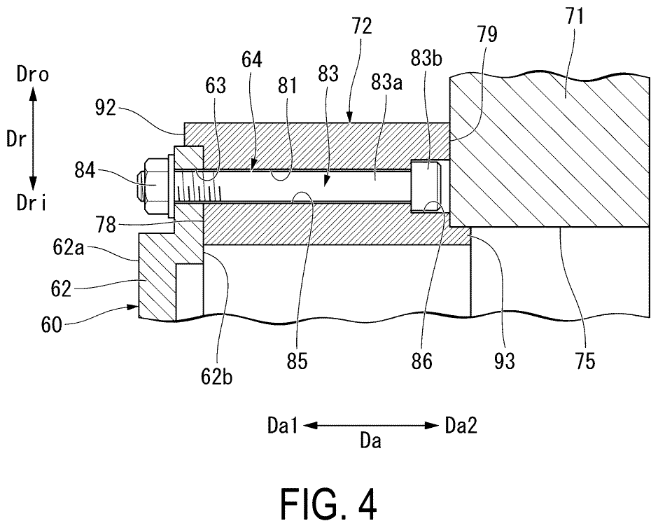

FIG. 4 is a cross-sectional view of a coupling attachment hole of the spacer according to the embodiment of the disclosure. FIG. 5 is a cross-sectional view of a threaded hole of the spacer according to the embodiment of the disclosure.

As illustrated in FIGS. 4 and 5, a coupling attachment hole (first attachment portion) 81 and a threaded hole (second attachment portion) 82 are formed in the spacer 72. The coupling attachment hole 81 is formed for joining the spacer 72 to the coupling hub 60, and the threaded hole 82 is formed for joining the worm wheel 71 to the spacer 72.

As illustrated in FIG. 3, a plurality of the coupling attachment holes 81 are formed at intervals in the circumferential direction Dc. The plurality of coupling attachment holes 81 are formed at positions where the plurality of coupling attachment holes 81 can face the insertion holes 63 formed in the joining portion 62 of the coupling hub 60 described above. As illustrated in FIG. 4, the spacer 72 illustrated as an example in the present embodiment is fastened to the coupling hub 60 by a bolt 83 and a nut 84 constituting the fastening member 64. The coupling attachment hole 81 extends through the spacer 72 in the axial direction Da.

The coupling attachment hole 81 of the present embodiment includes a small diameter portion 85 and a large diameter portion 86. The small diameter portion 85 is formed to have a diameter slightly larger than that of a shaft portion 83a of the bolt 83. On the other hand, the large diameter portion 86 is configured to accommodate a head portion 83b of the bolt 83. The large diameter portion 86 is formed to restrict rotation of the head portion 83b of the bolt 83 and help prevent the head portion 83b of the bolt 83 from protruding beyond the spacer 72 toward the axial direction second side Da2 in a state of accommodating the head portion 83b of the bolt 83.

As illustrated in FIGS. 3 and 5, a plurality of the threaded holes 82 of the spacer 72 are formed at intervals in the circumferential direction Dc. The plurality of threaded holes 82 are formed at positions different from those of the above-described coupling attachment holes 81 in the circumferential direction Dc. The threaded hole 82 opens in the second surface 79 of the spacer 72 and extends toward the axial direction first side Da1, and is configured to allow fastening a male thread portion 87 of the fastening member 65 such as a bolt for joining the worm wheel 71 by a screw action from the axial direction second side Da2. Here, the spacer 72 illustrated as an example in the present embodiment includes a first positioning protrusion 92 and a second positioning protrusion 93. The first positioning protrusion 92 has a ring shape protruding from the outer peripheral edge of the first surface 78 toward the axial direction first side Da1, and positions the spacer 72 in the radial direction Dr with respect to the coupling hub 60. The second positioning protrusion 93 has a ring shape protruding from the inner peripheral edge of the second surface 79 toward the axial direction second side Da2, and positions the spacer 72 in the radial direction Dr with respect to the worm wheel 71.

### Worm Portion

As illustrated in FIGS. 2 and 3, the worm portion 73 is a screw gear that meshes with the worm wheel 71, which is a helical gear. By turning the worm portion 73, the worm wheel 71 can be driven to rotate about the axis O1. The worm portion 73 of the present embodiment is detachably provided to the lower half 55 of the end flange portion 53 via the worm holding plate 74, the end flange portion 53 being a member (in other words, a stator) on the stationary side of the rotary machine 10.

As illustrated in FIG. 3, an axis O2 of the worm portion 73 extends in a tangential direction of a circumscribed circle of the worm wheel 71. The worm portion 73 includes shaft portions 73a at both ends thereof, and these two shaft portions 73a are supported by worm bearings 89 in a rotatable manner. At least one of the two shaft portions 73a of the worm portion 73 is formed protruding outward relative to the two worm bearings 89 in the direction in which the axis O2 extends. A socket portion of a hand tool 100, which will be described later, can be mounted to this portion 73b protruding outward. Examples of the shape of the portion 73b protruding outward include a hexagonal column and a quadrangular column extending in the direction of the axis O2.

The worm holding plate 74 is attachable to and detachable from the lower half 55 of the end flange portion 53 covering the coupling hub 60 from the lower side. The worm holding plate 74 includes a holding plate main body 90 having a plate shape and the above-described worm bearings 89 supporting the worm portion 73 in a rotatable manner.

The holding plate main body 90 of the present embodiment has a plurality of insertion holes 91 (see FIG. 2) extending through the holding plate main body 90 in the axial direction Da. The plurality of insertion holes 91 are formed at positions where the plurality of insertion holes 91 can face the plurality of threaded holes 57 formed in the attachment surface 56 of the end flange portion 53, respectively. Fastening members 66 such as bolts are inserted into the plurality of insertion holes 91. The worm holding plate 74 is fixed to the end flange portion 53 by the fastening members 66 being fastened to the threaded holes 57 by a screw action. That is, the worm holding plate 74 of the present embodiment is attached to the end flange portion 53 by effectively utilizing the threaded holes 57 of the end flange portion 53 formed to connect the coupling guard (not illustrated).

The holding plate main body 90 of the present embodiment is formed extending from the attachment surface 56 only to the outer peripheral side in the radial direction Dr centered at the axis O. The insertion hole 91 formed in the holding plate main body 90 of the present embodiment is disposed at a position overlapping the worm wheel 71 when viewed from the axial direction second side Da2. As illustrated in FIG. 3, the present embodiment illustrates as an example a case where the dimension of the holding plate main body 90 in the circumferential direction Dc gradually decreases toward the radial direction outward side Dro to approach the dimension of the worm portion 73 on the radial direction outward side Dro of the worm wheel 71 when viewed from the axial direction second side Da2. In the present embodiment, a case where the holding plate main body 90 has four insertion holes 91 is given as an example, but the number of insertion holes 91 is not limited to four. The worm portion 73 of the present embodiment is disposed on an obliquely lower left side of the worm wheel 71 when viewed from the axial direction second side Da2, but the disposition of the worm wheel 71 is not limited to the above disposition. The worm portion 73 may be disposed, for example, on a vertically lower side or an obliquely lower right side of the worm wheel 71 when viewed from the axial direction second side Da2.

### Phase Adjustment Method

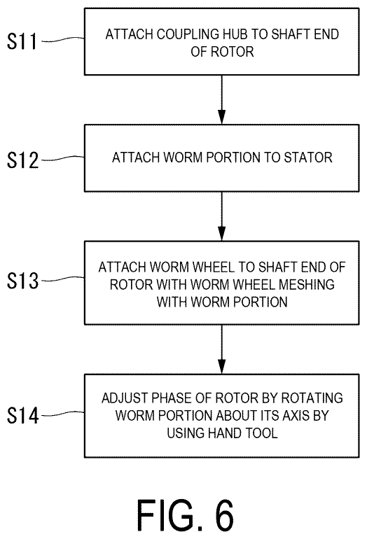

Next, a phase adjustment method for a rotary machine according to the embodiment of the disclosure will be described with reference to FIGS. 6 to 14.

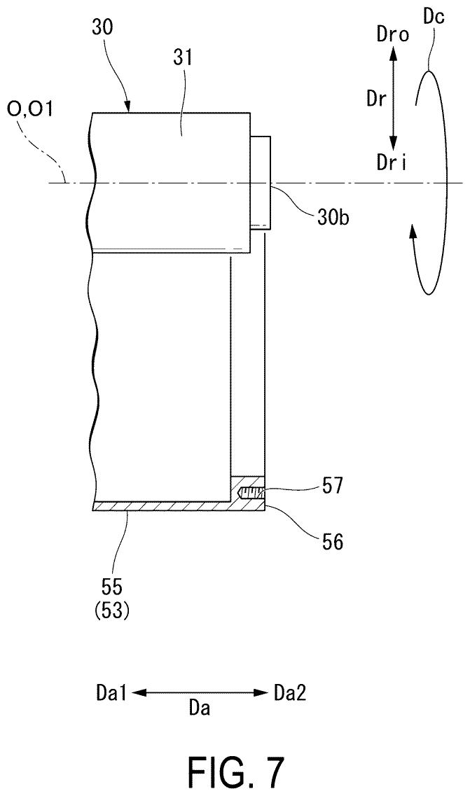

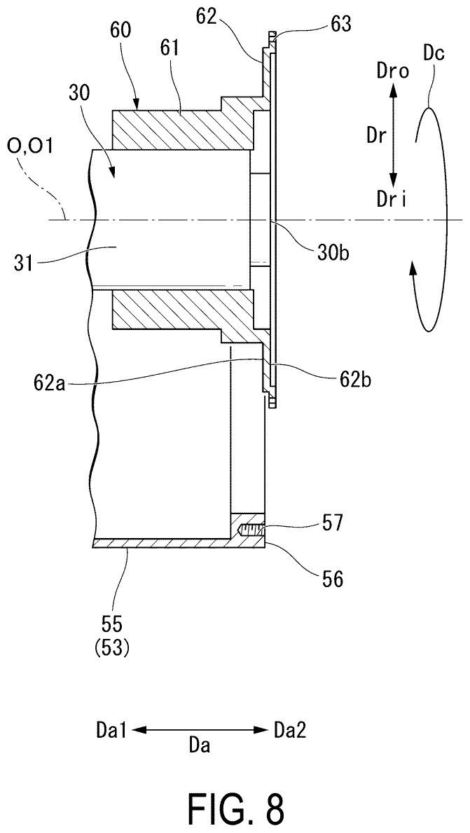

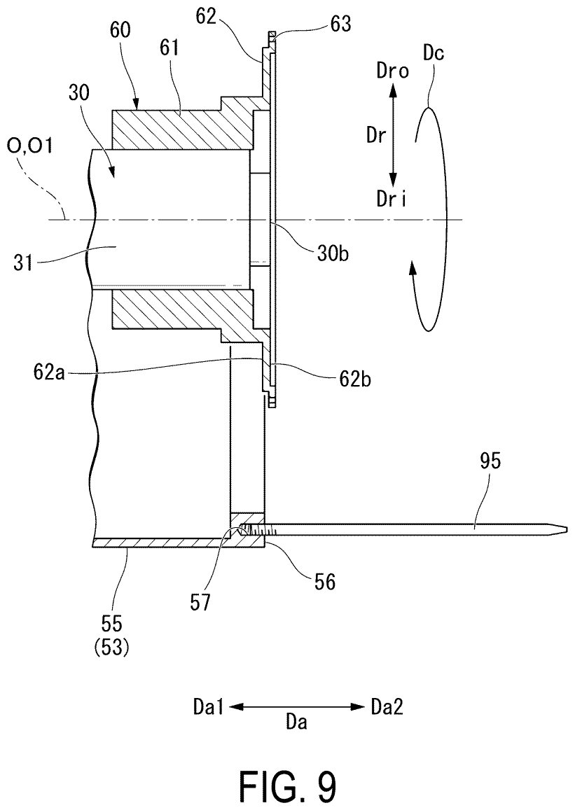

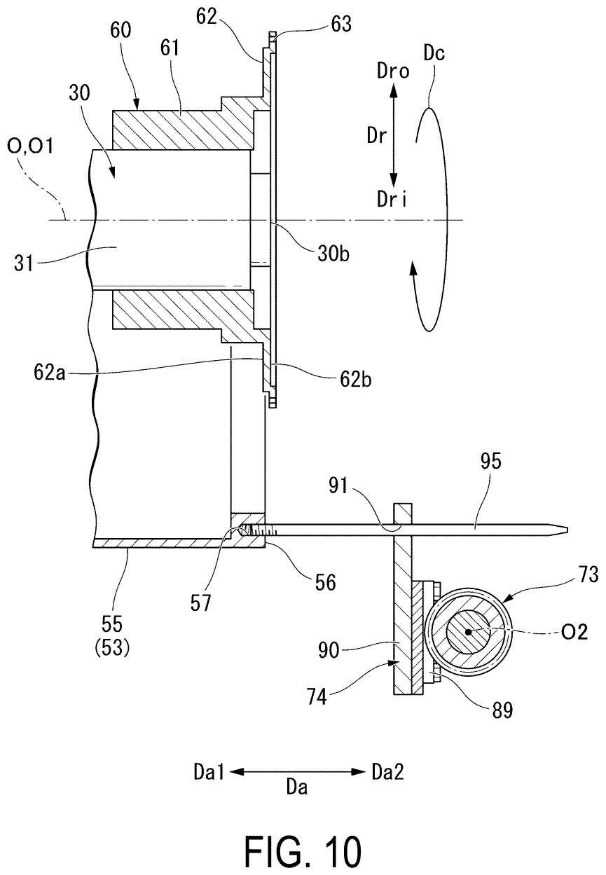

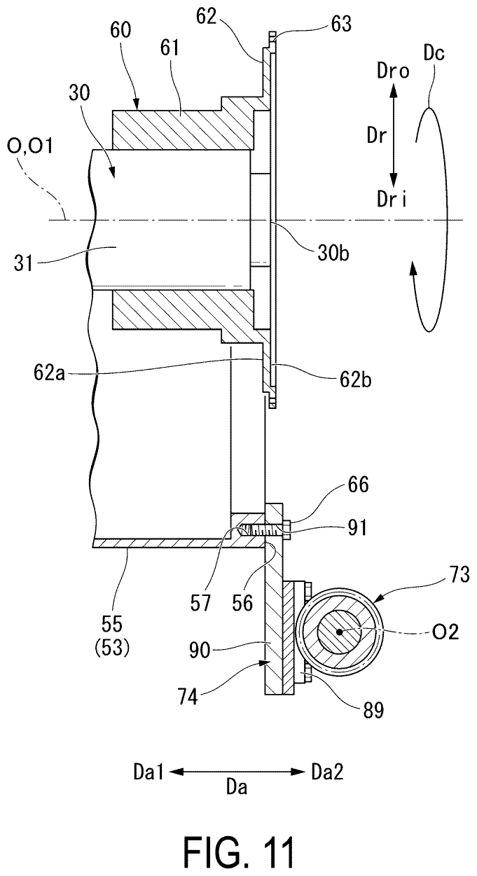

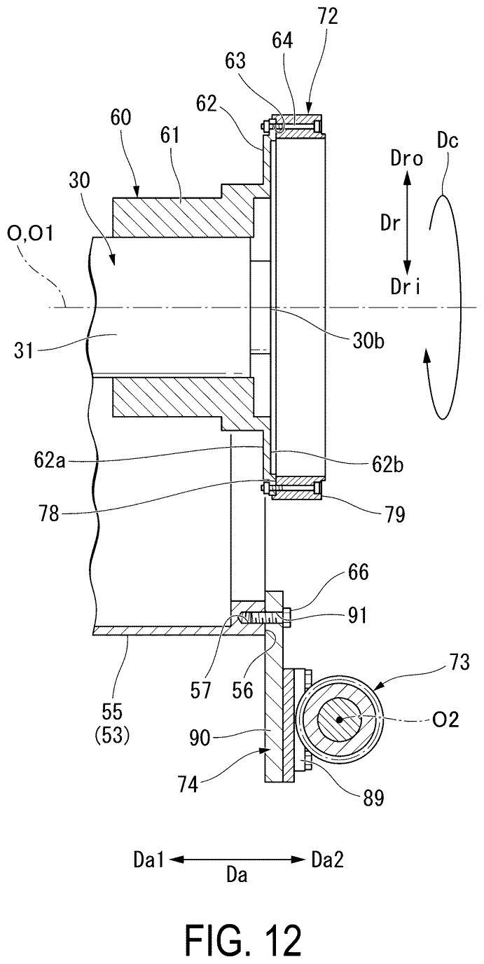

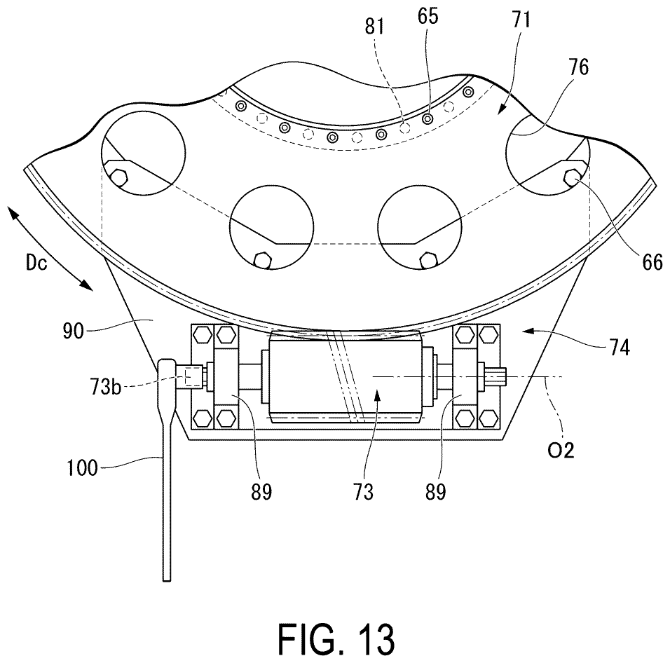

FIG. 6 is a flowchart of the phase adjustment method for the rotary machine according to the embodiment of the disclosure. FIG. 7 is a partial cross-sectional view of the vicinity of a shaft end when none of a phase adjustment device and a coupling hub are mounted according to the embodiment of the disclosure. FIG. 8 is a partial cross-sectional view illustrating a state in which the above-mentioned coupling hub is attached. FIG. 9 is a partial cross-sectional view illustrating a state in which a guide bar is attached in a threaded hole of an end flange portion. FIG. 10 is a partial cross-sectional view illustrating a state in which a guide bar is inserted into an insertion hole of a worm holding plate. FIG. 11 is a partial cross-sectional view illustrating a state in which a worm holding plate is attached to an end flange portion. FIG. 12 is a partial cross-sectional view illustrating a state in which a spacer is attached to a coupling hub. FIG. 13 is a diagram illustrating a state in which a hand tool is mounted to a worm portion.

As illustrated in FIG. 6, the phase adjustment method of the present embodiment includes step S11 of attaching a coupling hub to a shaft end of a rotor (hereinafter simply referred to as step S11), step S12 of attaching a worm portion to a stator (hereinafter simply referred to as step S12), step S13 of attaching a worm wheel to the shaft end of the rotor with the worm wheel meshing with the worm portion (hereinafter simply referred to as step S13), and step S14 of adjusting a phase of the rotor by rotating the worm portion about an axis of the worm portion by using a hand tool (hereinafter simply referred to as step S14).

In step S11, the coupling hub 60 is attached to the shaft end 31 of the rotor shaft 30. Step S11 is performed only in a case where the coupling hub 60 is not attached to the shaft end 31. In step S11, to the shaft end 31 of the rotor shaft 30 to which the coupling hub 60 has not yet been attached as illustrated in FIG. 7, the coupling hub 60 is attached as illustrated in FIG. 8. At this time, the coupling hub 60 is fixed to the shaft end 31 by inserting the shaft end 31 of the rotor shaft 30 into the base portion 61 of the coupling hub 60, where the coupling hub 60 is oriented such that the joining portion 62 is disposed on the axial direction second side Da2 of the base portion 61.

In step S12, the worm portion 73 is attached to the lower half 55 of the end flange portion 53. In the present embodiment, a case where the worm portion 73 is attached to the worm holding plate 74 and then the worm holding plate 74 is attached to the end flange portion 53 will be described as an example. Further, in the present embodiment, a case where the worm holding plate 74 attached with the worm portion 73 is heavy in weight and difficult to be lifted by human power will be described as an example.

In step S12 of the present embodiment, as illustrated in FIG. 9, first, a guide bar 95 having a cylinder shape and extending in the axial direction Da is attached in the threaded hole 57 formed in the attachment surface (end portion) 56 of the lower half 55 of the end flange portion 53. A male thread that can be screwed into the threaded hole 57 is formed at a base of the guide bar 95. The present embodiment illustrates as an example a case where a tip portion of the guide bar 95 has a tapered shape to be easily inserted into the insertion hole 91, but the tip shape of the guide bar 95 is not limited to this shape. The number of guide bars 95 is not particularly limited, and any number of guide bars 95 can be used in a range in which the number obtained by subtracting two from the number of insertion holes 91 formed in the worm holding plate 74 is taken as the upper limit. It is advantageous to provide a plurality of the guide bars 95 in that the orientation of the worm holding plate 74 can be stabilized.

Further, in step S12 of the present embodiment, the worm holding plate 74 is guided by the guide bar 95 to position the worm portion 73 and the lower half 55 of the end flange portion 53. In one example, as illustrated in FIG. 10, the guide bar 95 is inserted into the insertion hole 91 of the worm holding plate 74. At this time, the worm holding plate 74 may be lifted by using a crane or the like.

Subsequently, the worm holding plate 74 is slid along the guide bar 95 toward the axial direction first side Da1. Then, the worm holding plate 74 is brought into contact with the attachment surface 56 of the end flange portion 53. Thus, all the insertion holes 91 are in a state of being positioned facing the threaded holes 57. In this state, into the insertion hole 91 in which the guide bar 95 has not been inserted, the fastening member 66 is inserted from the axial direction second side Da2 to fasten the fastening member 66 in the threaded hole 57. Thereafter, the guide bar 95 is removed from the threaded hole 57, and thus the fastening member 66 is fastened in the threaded hole 57 as illustrated in FIG. 11. As a result, the fastening members 66 are fastened in the threaded holes 57 via all the insertion holes 91, and step S12 ends. In step S12 of the present embodiment, the case of using the guide bar 95 is described as an example. However, in a case where the worm holding plate 74 attached with the worm portion 73 can be easily lifted by human power or the like, the attachment may be performed without using the guide bar 95.

In step S13, the worm wheel 71 is attached to the shaft end 31 of the rotor shaft 30 with the worm wheel 71 meshing with the worm portion 73.

In step S13 of the present embodiment, as illustrated in FIG. 12, first, the spacer 72 is attached to the coupling hub 60. To do so, the spacer 72 is fastened to the joining portion 62 of the coupling hub 60 by using the fastening member 64. Thereafter, the worm wheel 71 is lifted by, for example, a crane or the like, and the worm wheel 71 is brought into contact with the spacer 72 in a state in which the threaded hole 82 of the spacer 72 and the wheel attachment hole 77 of the worm wheel 71 are in phase. At this time, the worm portion 73 is rotated so that the worm wheel 71 and the worm portion 73 mesh with each other. Then, the fastening member 65 is inserted into the wheel attachment hole 77 to be fastened in the threaded hole 82. Thus, as illustrated in FIGS. 2 and 3, the phase adjustment device 70 is mounted to the rotary machine 10.

As illustrated in FIG. 13, in step S14, the worm portion 73 is rotated about the axis O2 thereof by using the hand tool 100. As a result, the rotation of the worm portion 73 is transmitted to the worm wheel 71, so that the rotor shaft 30 rotates together with the worm wheel 71. An operator rotates the worm portion 73 by using the hand tool 100 while checking the phase of the rotor shaft 30. Thus, the phase of the rotor shaft 30 is adjusted to a desired phase. The present embodiment illustrates as an example a case where a socket wrench is used as the hand tool 100, but other hand tools may be used.

After the phase adjustment of the rotor shaft 30 is completed, the phase adjustment device 70 is removed in the reversed order of the above-described steps.

### Operational Effects

According to the embodiment described above, the worm portion 73 can be caused to be supported by the end flange portion 53, and the worm wheel 71 can be attached to the shaft end 31 of the rotor shaft 30 with the worm wheel 71 meshing with the worm portion 73. Because of this, it is unnecessary to secure a space for supporting the worm portion 73 around the rotary machine 10. In addition, the worm wheel 71 is rotated by using the worm portion 73, and thus a large deceleration effect can be easily obtained. This makes it possible to reduce the installation space and to easily adjust the phase of the rotor shaft 30.

Further, according to the above-described embodiment, the worm wheel 71 is attached to and detached from the coupling hub 60 provided at the shaft end 31 of the rotor shaft 30. With this, when the coupling hub 60 is already mounted to the shaft end 31 of the rotor shaft 30 of the rotary machine 10, the worm wheel 71 having a diameter larger than that of the coupling hub 60 can be attached by effectively utilizing the existing coupling hub 60. Therefore, it is unnecessary to prepare a dedicated attachment jig for attaching the worm wheel 71, and thus it is possible to suppress an increase in the number of components of the phase adjustment device 70.

In the embodiment described above, there is included the worm holding plate 74 attachable to and detachable from the end flange portion 53 covering the coupling hub 60 from the lower side, and the worm portion 73 is attached to and detached from the end flange portion 53 via the worm holding plate 74. This makes it possible to dispose the worm portion 73 at an appropriate position regardless of the disposition of the attachment surface 56 of the end flange portion 53. Accordingly, the present disclosure can be easily applied to the rotary machine 10 of various specifications only by adjusting the size of the worm holding plate 74 and the attachment position of the worm portion 73 with respect to the worm holding plate 74.

Further, in the above-described embodiment, the spacer 72 allows the worm wheel 71 to be disposed offset toward the axial direction second side Da2. Thus, the worm wheel 71 can be disposed at a position where the worm wheel 71 appropriately meshes with the worm portion 73 by changing the thickness of the spacer 72.

Furthermore, the spacer 72 includes the threaded hole 82 for attaching the worm wheel 71 and the coupling attachment hole 81 for fixing the spacer 72 to the coupling hub 60. With this, after the spacer 72 is attached to the coupling hub 60, the worm wheel 71 can be attached to the spacer 72. Therefore, the attachment work can be easily performed as compared to a case where the coupling hub 60 and the worm wheel 71 are fixed to each other by a bolt, a nut, and the like with the spacer 72 interposed between the coupling hub 60 and the worm wheel 71. This makes it possible to reduce the burden on the operator that performs the phase adjustment work of the rotor shaft 30.

Further, in the above-described embodiment, the worm wheel 71 can be driven by rotating the worm portion 73 by using the hand tool 100. Thus, the phase adjustment of the rotor shaft 30 can be easily performed by using the hand tool 100 even in a case where only a small space can be secured.

Further, in the above-described embodiment, the insertion holes 91 of the worm holding plate 74 can be accurately positioned with respect to the threaded holes 57 formed in the attachment surface 56 of the end flange portion 53 by using the guide bar 95. Thus, the worm holding plate 74 can be easily attached even when the weight of the worm holding plate 74 is large.

### OTHER EMBODIMENTS

The disclosure is not limited to the configuration of the above-described embodiment, and design modifications can be made without departing from the spirit of the disclosure.

For example, in the above-described embodiment, a case has been described where the rotary machine 10 to be adjusted in phase by the phase adjustment device 70 is a multistage centrifugal compressor. However, the rotary machine 10 is not limited to the multistage centrifugal compressor as long as it is difficult for the operator to rotate the rotor shaft 30 of the rotary machine 10 by hand.

In the above-described embodiment, a case has been described where the spacer 72 is used. However, the spacer 72 may be provided as necessary and may be omitted.

Further, in the above-described embodiment, a case has been described where the worm portion 73 is supported by the end flange portion 53. However, the location where the worm portion 73 is supported is not limited to the end flange portion 53 as long as the location is on the stationary side (stator). For example, the worm portion 73 may be caused to be supported by the other end portion 20b of the casing 20. The structure in which the worm portion 73 is caused to be supported by the stator is not limited to the above-described structure using the worm holding plate 74 as long as the structure allows the worm portion 73 and the worm wheel 71 to mesh with each other.

In the above-described embodiment, a case has been described where the worm wheel 71 is attached to the coupling hub 60 as an example. However, the worm wheel 71 may be directly attached to the second end portion 30b of the rotor shaft 30 by a bolt or the like, or may be attached to the shaft end 31 by using other dedicated jigs.

The above-described embodiment illustrates as an example a case where the worm portion 73 is turned by human power by using the hand tool 100. However, for example, a tool driven by power other than human power such as an electromotive tool, an air tool, or a hydraulic tool may be used.

### Supplementary Notes

The phase adjustment device and the phase adjustment method for the rotary machine described in the embodiments are understood as follows, for example.

(1) According to a first aspect, the phase adjustment device 70 for the rotary machine 10 is the phase adjustment device 70 for the rotary machine 10 including the rotor 30 and the stator 20, 55, the phase adjustment device 70 including: the worm wheel 71 configured to be detachably provided to the shaft end 31 of the rotor 30; and the worm portion 73 configured to be detachably provided to the stator 20, 55 and mesh with the worm wheel 71.

Examples of the rotor include a rotor shaft. Examples of the stator include an end flange portion and a casing.

Thus, the worm portion 73 can be caused to be supported by the stator 20, 55, and the worm wheel 71 can be attached to the shaft end 31 of the rotor 30 with the worm wheel 71 meshing with the worm portion 73. As a result, it is possible to reduce the installation space and to easily adjust the phase of the rotor 30.

(2) According to a second aspect, the phase adjustment device 70 for the rotary machine 10 is the phase adjustment device 70 for the rotary machine 10 described in (1), wherein the worm wheel 71 is attached to and detached from the coupling hub 60 provided at the shaft end 31 of the rotor 30.

Thus, the worm wheel 71 having a diameter larger than that of the coupling hub 60 can be attached by utilizing the coupling hub 60. Accordingly, it is unnecessary to prepare a dedicated attachment jig for attaching the worm wheel 71, and an increase in the number of components of the phase adjustment device 70 can be suppressed.

(3) According to a third aspect, the phase adjustment device 70 for the rotary machine 10 is the phase adjustment device 70 for the rotary machine 10 described in (2), wherein the phase adjustment device 70 further includes the worm holding plate 74 attachable to and detachable from the end flange portion 53 of the stator, the end flange portion 53 covering the coupling hub 60 from the lower side, and the worm portion 73 is attached to and detached from the end flange portion 53 via the worm holding plate 74.

This makes it possible to dispose the worm portion 73 at an appropriate position regardless of the disposition of the end flange portion 53.

(4) According to a fourth aspect, the phase adjustment device 70 for the rotary machine 10 is the phase adjustment device 70 for the rotary machine 10 described in (2) or (3), wherein the phase adjustment device 70 further includes the spacer 72 configured to be interposed between the coupling hub 60 and the worm wheel 71.

With this, the disposition of the worm wheel 71 in the axial direction Da can be changed only by changing the thickness of the spacer 72.

(5) According to a fifth aspect, the phase adjustment device 70 for the rotary machine 10 is the phase adjustment device 70 for the rotary machine 10 described in (4), wherein the spacer 72 includes the first attachment portion 81 provided on the first side Da1 of the axial direction Da, in which the axis O of the rotor 30 extends, and configured to allow fixing the spacer 72 to the coupling hub 60; and the second attachment portion 82 provided on the second side Da2 of the axial direction Da and configured to allow attaching the worm wheel 71.

Thus, the worm wheel 71 can be easily attached to the shaft end 31.

(6) According to a sixth aspect, a phase adjustment method for the rotary machine 10 is a phase adjustment method for the rotary machine 10 by the phase adjustment device 70 described in any one of (1) to (5), the method including: step S12 of attaching the worm portion 73 to the stator 20, 55; step S13 of attaching the worm wheel 71 to the shaft end 31 of the rotor 30 with the worm wheel 71 meshing with the worm portion 73; and step S14 of adjusting a phase of the rotor 30 by rotating the worm portion 73 about the axis O2 of the worm portion 73 by using the hand tool 100.

With this, even in a case where only a small space can be secured, the phase adjustment of the rotor 30 can be easily performed by using the hand tool 100.

(7) According to a seventh aspect, the phase adjustment method for the rotary machine 10 is the phase adjustment method for the rotary machine 10 described in (6), wherein in step S13 of attaching the worm wheel 71 to the shaft end 31 of the rotor 30 with the worm wheel 71 meshing with the worm portion 73, the worm wheel 71 is attached to the coupling hub 60 mounted to the shaft end 31 of the rotor 30, and in step S12 of attaching the worm portion 73 to the stator 20, 55, the worm holding plate 74 configured to support the worm portion 73 is positioned and attached to the end portion 56 of the end flange portion 53 covering the coupling hub 60.

Thus, the worm wheel 71 and the worm portion 73 can be easily attached to the rotary machine 10.

(8) According to an eighth aspect, the phase adjustment method for the rotary machine 10 is the phase adjustment method for the rotary machine 10 described in (7), wherein in step S12 of attaching the worm portion 73 to the stator 20, 55, the guide bar 95 extending in the axial direction Da of the rotor 30 is attached to the end portion 56 of the end flange portion 53, and the worm holding plate 74 is guided by the guide bar 95 to position the worm portion 73 and the end flange portion 53.

Thus, the worm holding plate 74 can be easily attached even in a case where the weight of the worm holding plate 74 is large.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A phase adjustment device for a rotary machine including a rotor and a stator, the phase adjustment device comprising:
a worm wheel configured to be detachably provided to a shaft end of the rotor; and
a worm portion configured to be detachably provided to the stator and mesh with the worm wheel.

2. The phase adjustment device for a rotary machine according to claim 1, wherein
the worm wheel is attached to and detached from a coupling hub provided at the shaft end of the rotor.

3. The phase adjustment device for a rotary machine according to claim 2, the phase adjustment device further comprising
a worm holding plate attachable to and detachable from an end flange portion of the stator, the end flange portion covering the coupling hub from a lower side, wherein
the worm portion is attached to and detached from the end flange portion via the worm holding plate.

4. The phase adjustment device for a rotary machine according to claim 2, the phase adjustment device further comprising
a spacer configured to be interposed between the coupling hub and the worm wheel.

5. The phase adjustment device for a rotary machine according to claim 4, wherein
the spacer includes
a first attachment portion provided on a first side of an axial direction in which an axis of the rotor extends, and configured to allow fixing the spacer to the coupling hub, and
a second attachment portion provided on a second side of the axial direction and configured to allow attaching the worm wheel.

6. A phase adjustment method by the phase adjustment device for a rotary machine according to claim 1, the phase adjustment method comprising:
attaching the worm portion to the stator;
attaching the worm wheel to the shaft end of the rotor with the worm wheel meshing with the worm portion; and
adjusting a phase of the rotor by rotating the worm portion about an axis of the worm portion by using a hand tool.

7. The phase adjustment method according to claim 6, wherein
in the attaching of the worm wheel to the shaft end of the rotor with the worm wheel meshing with the worm portion, the worm wheel is attached to a coupling hub mounted to the shaft end of the rotor, and
in the attaching of the worm portion to the stator, a worm holding plate configured to support the worm portion is positioned and attached to an end portion of an end flange portion covering the coupling hub.

8. The phase adjustment method according to claim 7, wherein
in the attaching of the worm portion to the stator, a guide bar extending in an axial direction of the rotor is attached to the end portion of the end flange portion, and the worm holding plate is guided by the guide bar to position the worm portion and the end flange portion.
